(19) United States
(12) Patent Application Publication
(10) Pub. No.: US 2010/0069094 A1
(43) Pub. Date: Mar. 18, 2010

(54) METHODS AND SYSTEMS FOR CELL RESELECTION IN IDLE MODE FOR A MOBILE WIMAX NETWORK

(75) Inventors: Tom Chin, San Diego, CA (US); Kuo-Chun Lee, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/211,904

(22) Filed: Sep. 17, 2008

(51) Int. Cl. H04W 68/00

(52) U.S. Cl. 455/458

(57) ABSTRACT

Certain embodiments of the present disclosure provide a technique for selecting a base station during a cell re-selection process in a manner that reduces the number of location updates sent by a mobile station. The technique may include determining a set of available base stations and selecting a base station from the set of available base stations based, at least in part, on paging group identifications (PGIDs) of the base stations in the set of available base stations. By giving preference to a base station with a PGID that matches the PGID of a current serving base station, a mobile station may avoid sending a location update.

### TECHNICAL FIELD

Certain embodiments of the present disclosure generally relate to wireless communication and, more particularly, to cell reselection for a mobile station in idle mode.

### BACKGROUND

Mobile WiMAX standards define an idle mode during which a mobile station (MS) may power down components in an effort to conserve power. In the idle mode, the MS powers up components to monitor for page messages in recurring MS Paging Listening (“listening”) intervals, while powering down components in MS Paging Unavailable (“sleep”) intervals.

In order for the WiMAX Access Service Network (ASN) to locate MS, MS needs to perform location update procedures. Location update operations may be performed in response to different triggering mechanisms. For example, one such mechanism is a change in paging group. Each base station (BS) belongs to one or more paging group. The paging group ID is typically transmitted through a Downlink Channel Descriptor (DCD) message or a BS mobile paging advertisement (MOB_PAG-ADV) broadcast message.

When an MS wakes up from idle and detects that it is moving to a new BS with a different paging group ID than its current serving BS, the MS needs to perform location update operations through the new BS. Unfortunately, location update operations consume air interface bandwidth and processing resources.

Accordingly, it would be desirable to reduce how often location update operations are performed.

### SUMMARY

Certain embodiments provide a method for selecting a base station during a cell re-selection process. The method generally includes determining a set of available base stations and selecting a base station, from the set of available base stations based, at least in part, on paging group identifications (PGIDS) of the base stations in the set of available base stations.

Certain embodiments provide an apparatus for selecting a base station during a cell re-selection process. The apparatus generally includes logic for determining a set of available base stations and logic for selecting a base station, from the set of available base stations based, at least in part, on paging group identifications (PGIDs) of the base stations in the set of available base stations.

Certain embodiments provide an apparatus for selecting a base station during a cell re-selection process. The apparatus generally includes means for determining a set of available base stations and means for selecting a base station, from the set of available base stations based, at least in part, on paging group identifications (PGIDs) of the base stations in the set of available base stations.

Certain embodiments provide a computer-program product for selecting a base station during a cell re-selection process comprising a computer readable medium having instructions stored thereon, the instructions being executable by one or more processors. The instructions generally include instructions for determining a set of available base stations and instructions for selecting a base station, from the set of available base stations based, at least in part, on paging group identifications (PGIDs) of the base stations in the set of available base stations.

Certain embodiments, as presented herein and in the paragraphs above, support OFDMA communications in accordance with one or more standards of the Institute of Electrical and Electronics Engineers (IEEE) 802.16 family of standards.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain embodiments of the present disclosure.

FIG. 2 illustrates various components that may be utilized in a wireless device in accordance with certain embodiments of the present disclosure.

FIG. 3 illustrates an example transmitter and receiver in accordance with certain embodiments of the present disclosure.

FIG. 4 illustrates a plurality of cells belonging to two paging groups, in accordance with embodiments of the present disclosure.

FIG. 5 illustrates example operations for cell re-selection, in accordance with embodiments of the present disclosure.

FIG. 5A illustrates example components capable of performing the operations of FIG. 5.

FIGS. 6A and 6B illustrate examples of cell reselection, in accordance with embodiments of the present disclosure.

### DETAILED DESCRIPTION

Embodiments of the present disclosure may allow a WiMAX mobile station to reduce the transmission of unnecessary location updates when selecting a preferred cell following an interval spent in an idle mode. Specifically, embodiments may provide a method and an apparatus for selecting a preferred cell based, at least in part, on a signal strength, or a relative signal strength, and a paging group id of candidate base stations.

### Exemplary Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16x is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

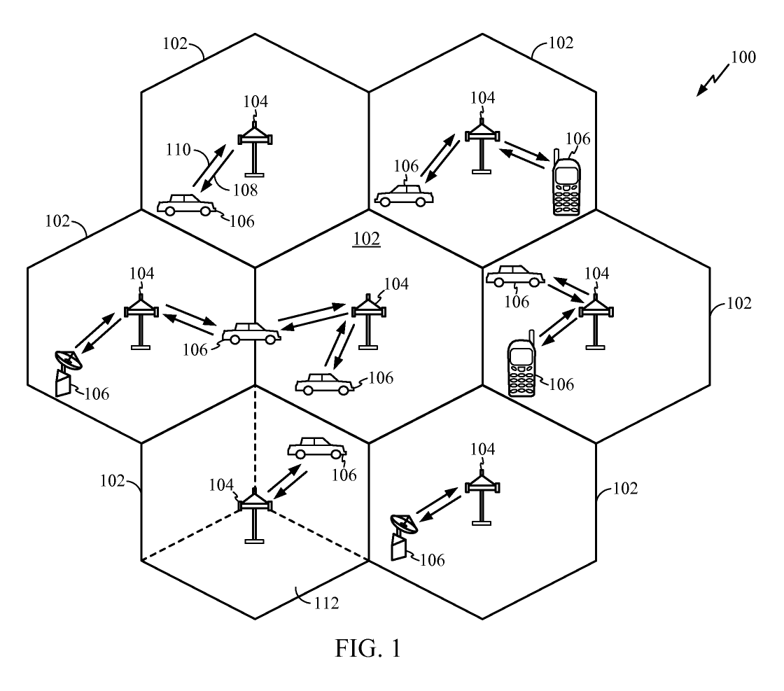

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

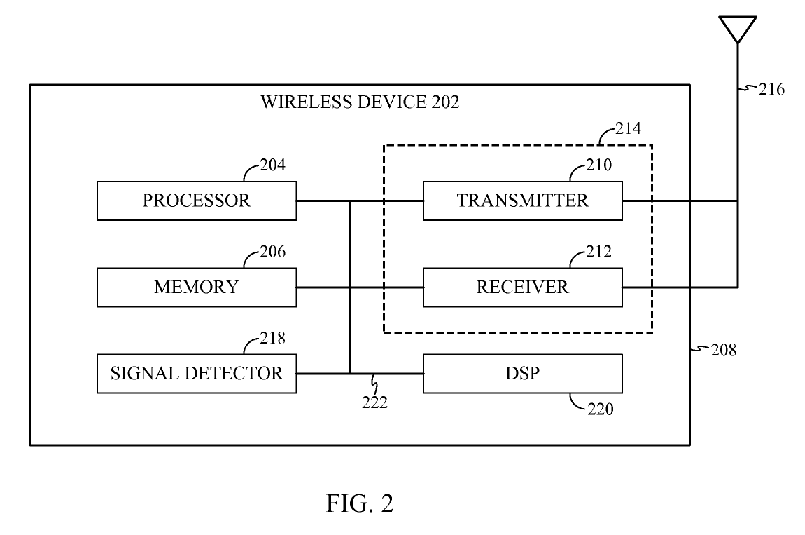

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per subcarrier and symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

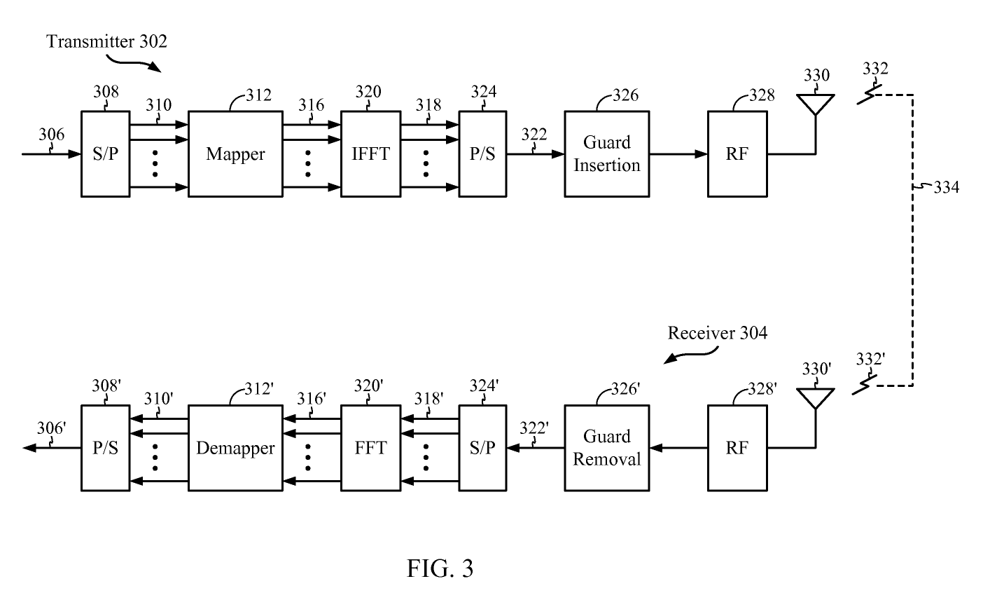

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 3 10.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

### Exemplary Cell Selection Following Idle Mode

Current versions of the Mobile WiMAX standard define mobile station (MS) idle mode operations such that the MS powers up components to monitor for BS Broadcast Paging (MOB_PAG-ADV) messages during a recurring listening interval while the MS may sleep (with components powered down in an MS Paging Unavailable Interval) during other time intervals. In order for a WiMAX Access Service Network (ASN) to locate the MS, the MS may be required to regularly perform a set of location update procedures. The performance of location update procedures may be triggered by a variety of different events.

For example, one such event is if the MS moves to a BS that is in a different paging group. This may occur, for example, when an MS wakes up from the unavailable period in idle mode, and detects a loss of communication with the previously serving BS. The MS may detect itself in the coverage of one or more new BSs. Each base station (BS) may belong to one or more paging groups. When an MS changes to monitor a new BS with a paging group ID (PGID) different than the PGID of the previous serving BS, the MS may need to perform location update procedures through the new BS (so that it is reachable through page requests).

However, as previously described, messages associated with location update procedures (location updates) require air interface bandwidth and processor time. The techniques presented herein may help reduce the number of location updates performed by an MS and, thus, help conserve air and processor resources.

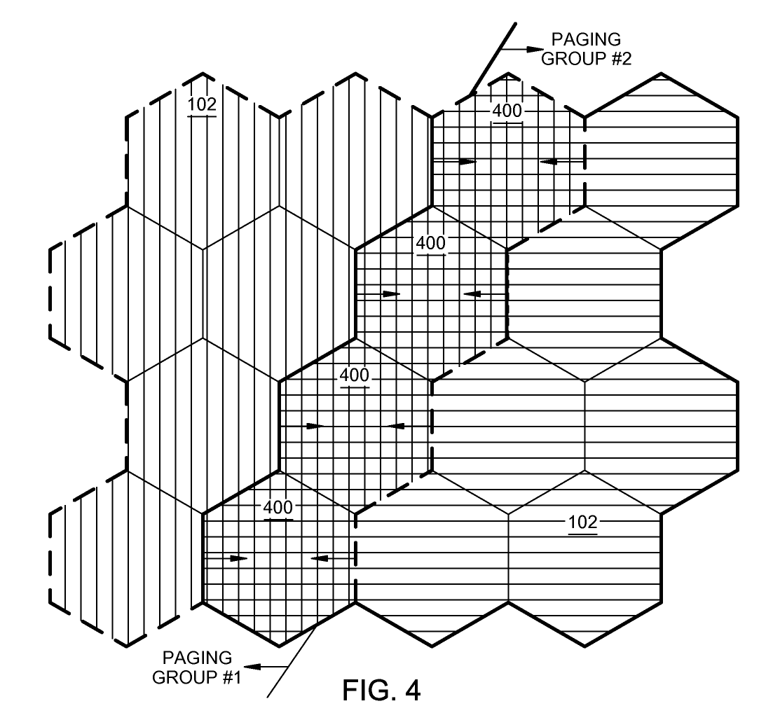

According to certain embodiments of the present disclosure, when an MS anticipates a change of BS for monitoring page messages in idle mode and is in a position within the coverage of a plurality of BSs, the MS may select a preferred BS in such a manner as to limit unnecessary location updates. For example, rather than simply select a preferred BS based on signal quality, the MS may also consider whether selecting a candidate BS belongs to a different paging group and would, thus, result in location updates. If so, the MS may instead select a different BS in a current paging group, provided that BS meets certain criteria. Cell reselection in accordance with the present disclosure may be described with reference to FIGS. 4-6.

FIG. 4 illustrates a plurality of cells 102 belonging to different paging groups. Paging groups offer a contiguous coverage region in which the MS does not need to transmit uplink MAC management messages every time after a change of BS for monitoring the page messages, yet is still available to be paged if there is traffic targeted at it. As illustrated, some cells may belong to more than one paging group, as illustrated by cells 400.

An MS may determine the paging group of a given BS by receiving the PGIDs through a downlink channel descriptor (DCD) message. The DCD message may be carried in the payload of a Media Access Control (MAC) protocol data unit (PDU) as part of a downlink map (DL-MAP) MAC management message transmitted periodically by the BS. As will be described herein, when selecting a BS to monitor the page messages in idle mode, the MS may acquire the DCD or MOB_PAG-ADV messages of multiple BSs with sufficient signal strength (e.g., above a certain threshold value) to know their Paging Group IDs. The MS may then give preference to BSs that are in the same paging group as a current serving BS.

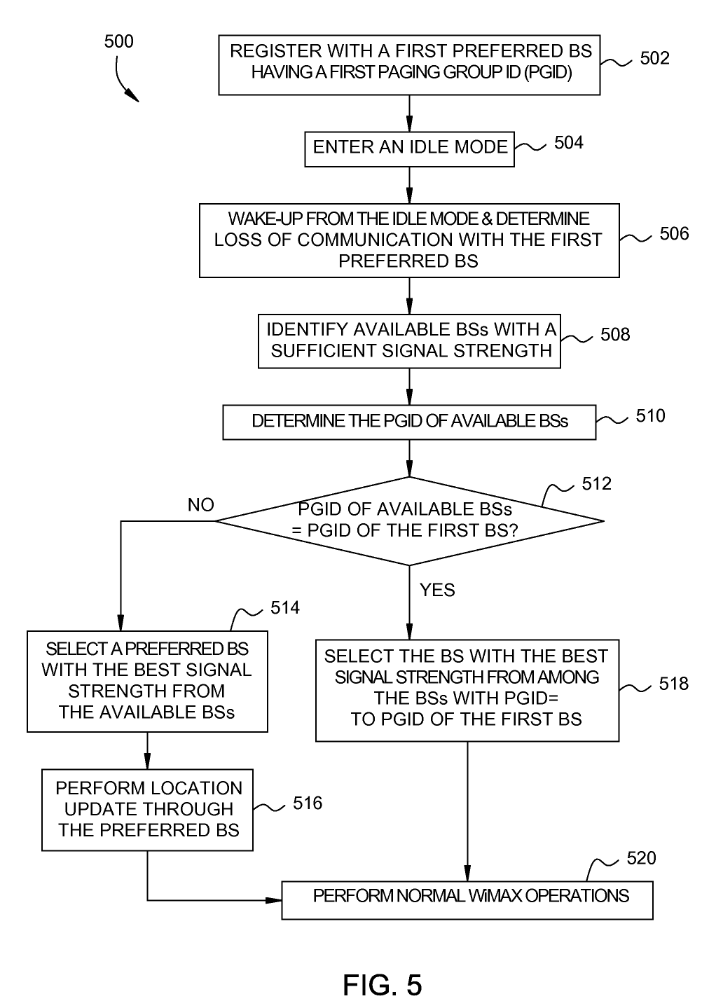

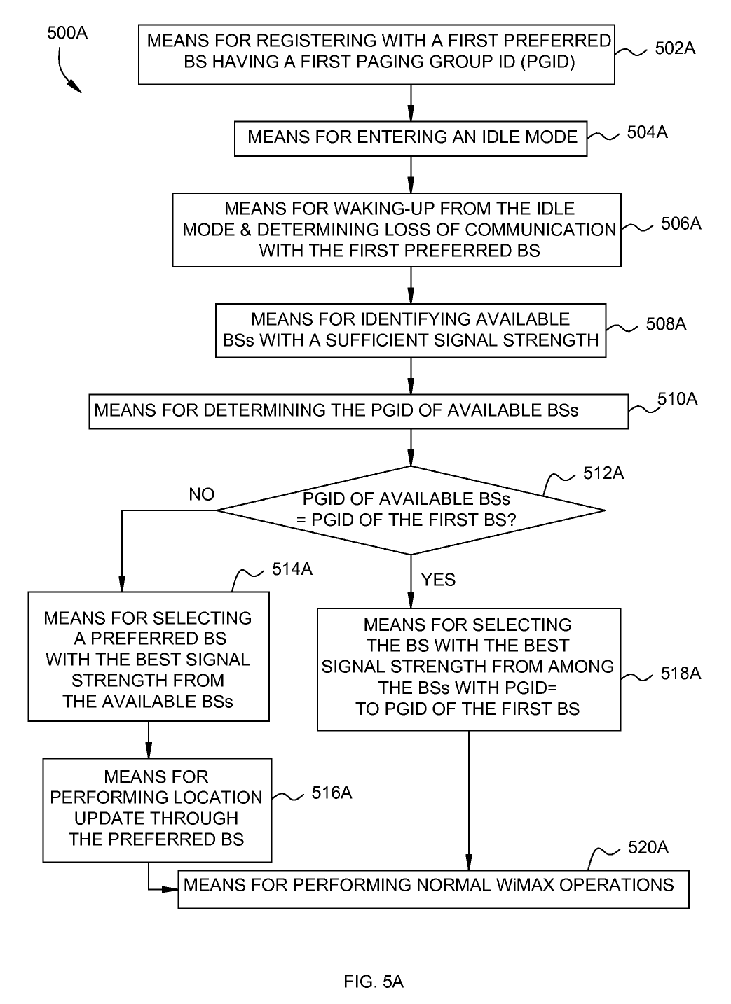

FIG. 5 illustrates example operations 500 performed, for example, by an MS for cell re-selection following an MS Paging Unavailable (sleep) interval of an idle mode. Operations begin, at 502, with a MS registering with an initial preferred BS having a first paging group ID. After registering with the initial preferred BS, the MS may perform normal WiMAX operations with the initial preferred BS.

At some point in time subsequent to registering with the initial preferred BS, the MS may enter an idle mode, as illustrated at 504. The MS may initiate idle mode, for example, by sending a de-registration request (DREG-REQ) to the current serving BS. The BS may also initiate an idle mode by sending an unsolicited de-registration command (DREG-CMD).

At 506, the MS may awake from a sleep interval of the idle mode and determine there is a loss of communication with the serving BS. For example, during the sleep interval, the MS may have moved to a location where the current serving BS has an insufficient signal strength.

Consequently, the MS may need to select a new preferred BS by scanning for a radio frequency (RF) channel. As part of the scanning procedure, the MS may determine the signal strength of various neighboring BSs. The MS may have any suitable measure of signal quality, such as the carrier to interference ratio (CIR), the carrier to noise ratio (CNR), and the carrier to interference plus noise ratio (CINR).

At 508, the MS may identify the available BSs, for example, that are suitable candidates for monitoring the page messages with sufficient signal strength (e.g., above a threshold value, relative signal strength).

At 510, the MS may determine the paging group ID of each of the available BSs. For example, the MS may acquire a DCD or MOB_PAG-ADV message of each available BS and determine the paging group(s) associated with each BS. To limit the processing involved in the acquisition of DCD or MOB_PAG-ADV messages, for certain embodiments, the number of available BSs for which such messages are processed to determine PGIDs may be limited to some small number (e.g., 2 or 3 with the highest signal strength). Given the PGIDs of the available BSs, the MS may give preference to a BS with the same PGID as the current serving BS, in an effort to avoid a location update.

At 512, the MS may examine the paging group IDs (PGIDs) associated with each BS and determine if one or more available BSs have a PGID equal to the PGID of the current serving (initially preferred) BS.

If none of the available BSs has a PGID equal to the PGID of the initial preferred BS, the MS may select a preferred BS, for example, in a conventional manner, based on the best signal strength available, at 514. Due to the change in paging groups, the MS may perform a location update through the newly selected BS, at 516. The MS may then, at 520, commence normal WiMAX operations via the new BS.

If, on the other hand, an available BS has a PGID equal to the PGID of the current serving BS, the MS may select that BS as the preferred BS and avoid a location update. In some instances, a plurality of BSs may have a PGID equal to the PGID of the current serving BS. To select between the plurality of BSs, the MS may select the BS with the best signal strength, at 518, and commence normal WiMAX operations via the new BS, at 520.

While the cell re-selection technique has been described with reference to an MS exiting a sleep interval of an idle mode, the MS may perform the same operations to re-select a preferred BS based, at least in part on PGID, during any state in idle mode. For example, if, during a listening interval in idle mode, the MS determines the signal strength of a current serving BS is below a threshold value, the MS may perform operations 508 through 520, in accordance with embodiments of the present disclosure.

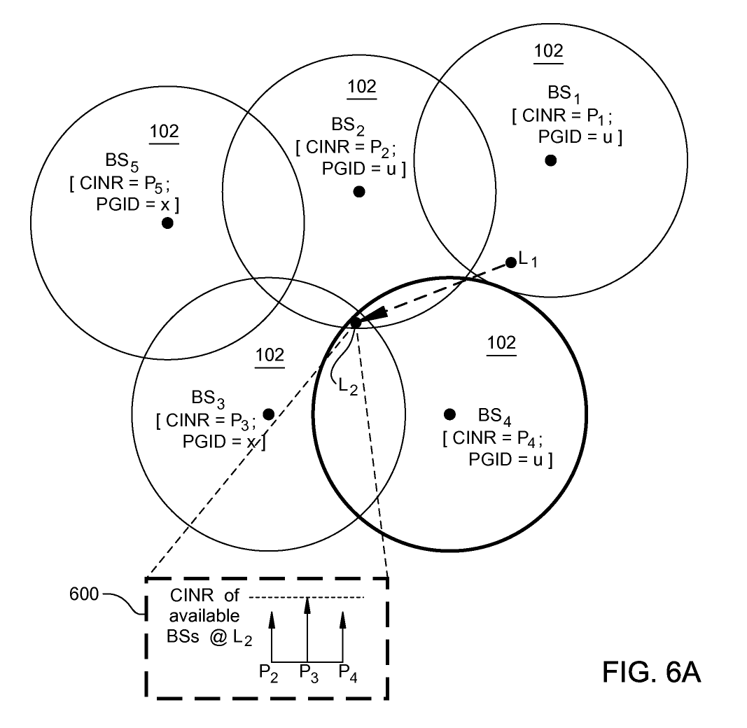

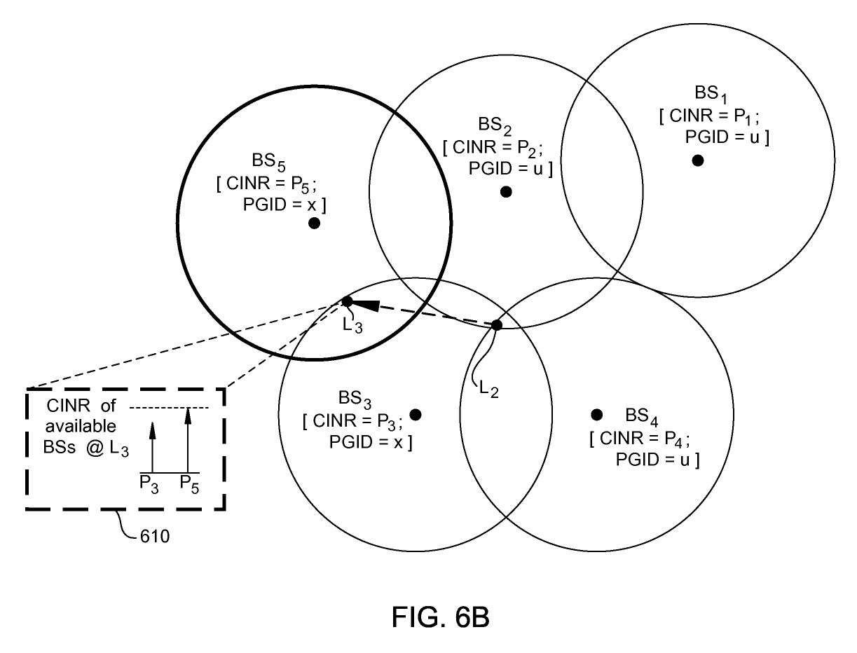

FIGS. 6A and 6B illustrate example cell reselection scenarios that demonstrate the cell re-selection techniques presented herein that take into consideration to paging group ID of a base station that is considered for selection. As illustrated, the example assumes an environment with five base stations, BS₁₋₅, having partially overlapping cells, associated with two different paging groups (e.g., PGID=u and PGID=x).

As illustrated in FIG. 6A, an MS may move from an initial location L1, served by BS₁ in paging group u, to a new location L2. In location L2, the connection with BS₁ may be lost.

Consequently, the MS may have to reselect a new preferred BS for monitoring the page messages. After scanning for a radio frequency (RF) channel and determining the signal strength of the corresponding BSs, the MS may determine that there are three available BSs (illustratively, BS₂, BS₃, and BS₄) from which to select.

As illustrated in the signal strength chart 600, at location L2, the MS may see the strongest signal from BS₃, followed by BS₄, and then BS₂. However, the MS may determine that BS₃ is a member of a paging group (PGID=x) different from the paging group of BS₁ (PGID=u). Accordingly, despite BS₃ having the best signal strength, the MS may select BS₄ as the preferred BS to avoid sending a location update.

In some instances, however, an MS may not avoid a location update. For example, as illustrated in FIG. 6B, the MS may determine that none of the available BSs are a member of the paging group equal to the paging group of the initial preferred BS. FIG. 6B illustrates a MS that moved from a location L2, where the preferred base station BS₄ had a PGID of ‘u,’ to a location L3, where both the available BSs (i.e., BS3 and BS₅) have a PGID of ‘x.’ In such instances, the MS may select a preferred BS (e.g., BS₅) based solely on the signal strength, as illustrated in the signal strength chart 610.

As described herein, by performing cell re-selection based, at least in part, on paging group IDs, the number of location updates transmitted by an MS may be significantly reduced. Reducing the number of location updates may help preserve air and processing resources.

The various operations of methods described above may be performed by various hardware and/or software component(s) and/or module(s) corresponding to means-plus-function blocks illustrated in the Figures. Generally, where there are methods illustrated in Figures having corresponding counterpart means-plus-function Figures, the operation blocks correspond to means-plus-function blocks with similar numbering. For example, blocks 502-520 illustrated in FIG. 5 correspond to means-plus-function blocks 502A-520A illustrated in FIG. 5A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for selecting a base station during a cell re-selection process, comprising:
determining a set of available base stations; and
selecting a base station, from the set of available base stations based, at least in part, on paging group identifications (PGIDs) of the base stations in the set of available base stations.

2. The method of claim 1, wherein selecting a base station based, at least in part, on PGIDs of the base stations in the set of available base stations comprises:
selecting a base station that has a PGID that is the same as a PGID of a currently serving base station.

3. The method of claim 2, wherein selecting a base station that has a PGID that is the same as a PGID of a currently serving base station comprises:
selecting a base station, from a group of base stations having the same PGID as the currently serving base station, based on relative signal strength of the group of base stations.

4. The method of claim 1, wherein selecting a base station based, at least in part, on paging group identifications (PGIDs) of the base stations in the set of available base stations, comprises:
determining that none of set of available base stations have a PGID that matches the PGID of a current serving base station;
selecting, from the set of available base stations, a base station based on relative signal strength; and
performing a location update to report a PGID of the selected base station.

5. The method of claim 1, further comprising:
waking up from a MS Paging Unavailable interval of an idle mode; and
performing a base station scan to determining the set of available base stations.

6. The method of claim 1, further comprising:
acquiring one or more downlink channel descriptor (DCD) messages for at least some of the available base stations; and
obtaining PGIDs for the at least some of the available base stations from the DCD messages.

7. The method of claim 1, further comprising:
acquiring one or more BS Broadcast Paging (MOB_PAG-ADV) messages for at least some of the available base stations; and
obtaining PGIDs for the at least some of the available base stations from the MOB_PAG-ADV messages.

8. An apparatus for selecting a base station during a cell re-selection process, comprising:
logic for determining a set of available base stations; and
logic for selecting a base station, from the set of available base stations based, at least in part, on paging group identifications (PGIDs) of the base stations in the set of available base stations.

9. The apparatus of claim 8, wherein the logic for selecting a base station is configured to select a base station that has a PGID that is the same as a PGID of a currently serving base station.

10. The apparatus of claim 9, wherein the logic for selecting a base station is configured to select a base station, from a group of base stations having the same PGID as the currently serving base station, based on relative signal strength of the group of base stations.

11. The apparatus of claim 8, wherein the logic for selecting a base station is configured to:
determine that none of set of available base stations have a PGID that matches the PGID of a current serving base station;
select, from the set of available base stations, a base station based on relative signal strength; and
perform a location update to report a PGID of the selected base station.

12. The apparatus of claim 8, further comprising:
logic for waking up from a MS Paging Unavailable interval of an idle mode; and
logic for performing a base station scan to determining the set of available base stations.

13. The apparatus of claim 8, further comprising:
logic for acquiring one or more downlink channel descriptor (DCD) messages for at least some of the available base stations; and
logic for obtaining PGIDs for the at least some of the available base stations from the DCD messages.

14. The apparatus of claim 8, further comprising:
logic for acquiring one or more BS Broadcast Paging (MOB_PAG-ADV) messages for at least some of the available base stations; and
logic for obtaining PGIDs for the at least some of the available base stations from the MOB_PAG-ADV messages.

15. An apparatus for selecting a base station during a cell re-selection process, comprising:
means for determining a set of available base stations; and
means for selecting a base station, from the set of available base stations based, at least in part, on paging group identifications (PGIDs) of the base stations in the set of available base stations.

16. The apparatus of claim 15, wherein the means for selecting a base station is configured to select a base station that has a PGID that is the same as a PGID of a currently serving base station.

17. The apparatus of claim 16, wherein the means for selecting a base station is configured to select a base station, from a group of base stations having the same PGID as the currently serving base station, based on relative signal strength of the group of base stations.

18. The apparatus of claim 15, wherein the means for selecting a base station is configured to:
determine that none of set of available base stations have a PGID that matches the PGID of a current serving base station;
select, from the set of available base stations, a base station based on relative signal strength; and
perform a location update to report a PGID of the selected base station.

19. The apparatus of claim 15, further comprising:
means for waking up from a MS Paging Unavailable interval of an idle mode; and
means for performing a base station scan to determining the set of available base stations.

20. The apparatus of claim 15, further comprising:
means for acquiring one or more downlink channel descriptor (DCD) messages for at least some of the available base stations; and
means for obtaining PGIDs for the at least some of the available base stations from the DCD messages.

21. The apparatus of claim 15, further comprising:
means for acquiring one or more BS Broadcast Paging (MOB_PAG-ADV) messages for at least some of the available base stations; and
means for obtaining PGIDs for the at least some of the available base stations from the MOB_PAG-ADV messages.

22. A computer-program product for selecting a base station during a cell re-selection process, comprising a computer readable medium having instructions stored thereon, the instructions being executable by one or more processors and the instructions comprising:
instructions for determining a set of available base stations; and
instructions for selecting a base station, from the set of available base stations based, at least in part, on paging group identifications (PGIDs) of the base stations in the set of available base stations.

23. The computer-program product of claim 22, wherein the instructions for selecting a base station based, at least in part, on PGIDs of the base stations in the set of available base stations comprise:
instructions for selecting a base station that has a PGID that is the same as a PGID of a currently serving base station.

24. The computer-program product of claim 23, wherein the instructions for selecting a base station that has a PGID that is the same as a PGID of a currently serving base station comprise:
instructions for selecting a base station, from a group of base stations having the same PGID as the currently serving base station, based on relative signal strength of the group of base stations.

25. The computer-program product of claim 22, wherein the instructions for selecting a base station based, at least in part, on paging group identifications (PGIDs) of the base stations in the set of available base stations, comprise:
instructions for determining that none of set of available base stations have a PGID that matches the PGID of a current serving base station;
instructions for selecting, from the set of available base stations, a base station based on relative signal strength; and
instructions for performing a location update to report a PGID of the selected base station.

26. The computer-program product of claim 22, wherein the instructions further comprise:
instructions for waking up from a MS Paging Unavailable interval of an idle mode; and
instructions for performing a base station scan to determining the set of available base stations.

27. The computer-program product of claim 22, further comprising:
instructions for acquiring one or more downlink channel descriptor (DCD) messages for at least some of the available base stations; and
instructions for obtaining PGIDs for the at least some of the available base stations from the DCD messages.

28. The computer-program product of claim 22, further comprising:
instructions for acquiring one or more BS Broadcast Paging (MOB_PAG-ADV) messages for at least some of the available base stations; and
instructions for obtaining PGIDs for the at least some of the available base stations from the MOB_PAG-ADV messages.
